(19) United States
(12) Patent Application Publication
(10) Pub. No.: US 2005/0046951 A1
(43) Pub. Date: Mar. 3, 2005

(54) Video display apparatus capable of displaying different videos according to observing direction

(75) Inventors: Ryohei Sugihara, Hachioji-shi (JP); Yoichi Iba, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS CORPORATION, TOKYO (JP)

(21) Appl. No.: 10/928,298

(22) Filed: Aug. 27, 2004

(30) Foreign Application Priority Data
Aug. 29, 2003 (JP) 2003-209756

(51) Int. Cl. G03B 21/26; G02B 27/10

(52) U.S. Cl. 359/619

(57) ABSTRACT

A video display apparatus has one display screen capable of displaying a video corresponding to each of a plurality of observers. An illumination unit emits a first luminous flux and a second luminous flux in at least two different directions in a time divisional manner. A transmission-type display element displays respectively in a time divisional manner by means of raster scanning a first video whose light source is the first luminous flux and a second video whose light source is the second luminous flux. An illumination switching unit sequentially switches two luminous fluxes in synchronism with movement of a boundary portion between the first video and the second video in a display screen of the transmission-type display element.

### CROSS-REFERENCE TO RELATED APPLICATIONS

This application is based upon and claims the benefit of priority from prior Japanese Patent Application No. 2003-209756, filed Aug. 29, 2003, the entire contents of which are incorporated herein by reference.

### BACKGROUND OF THE INVENTION

1. Field of the Invention

The present invention relates to a video display apparatus, and more particularly, to a video display apparatus capable of displaying different videos according to an observer's observing direction.

2. Description of the Related Art

Conventionally, it has been well known that a video display apparatus is capable of viewing a different video according to an observer's observing direction. For example, Japanese Patent No. 3398999 discloses a multiple video display apparatus capable of providing different videos in a plurality of directions by positioning a lenticular lens plate at a surface of a display element composed of a first pixel group and a second pixel group. In addition, Japanese Patent No. 3072866 discloses a three-dimensional video display apparatus for positioning a lenticular lens at a matrix shaped back light to change directivity in a time divisional manner and make a three-dimensional video display.

### BRIEF SUMMARY OF THE INVENTION

According to the first aspect of the present invention, there is provided a video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
an illumination switching unit which sequentially switches the two light fluxes emitted from the illumination unit in synchronism with movement of a boundary portion between the first video and the second video in the display screen of the transmission-type display element.

According to the second aspect of the present invention, there is provided a video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
a display mode switching unit to switch between a multiple video display mode in which the transmission-type display element displays the first video and second video in a time divisional manner and a single video display mode in which the transmission-type display element displays any one of the first video and the second video.

According to the third aspect of the present invention, there is provided a three-dimensional video display apparatus for inputting a corresponding parallax video into each of left and right eyes in one observer to display a three-dimensional video, the apparatus comprising:
an illumination unit which emits a first luminous flux and a second luminous in two directions which correspond to the left and right eyes in a time divisional manner;
a transmission-type display element capable of displaying respectively in a time divisional manner by means of raster scanning a first video whose light source is the first luminous flux and a second video whose light source is the second luminous flux, emitted from the illumination unit, the first video being input into the left eye and the second video being input into the right eye; and
an illumination switching unit which sequentially switches the two luminous fluxes emitted from the illumination unit in synchronism with movement of a boundary portion between the first video and the second video in a display screen of the transmission-type display element.

According to the fourth aspect of the present invention, there is provided a vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner; and
a transmission-type display element capable of displaying respectively in a time divisional manner a first video whose light source is the first luminous flux and a second video whose light source is the second luminous flux, emitted from the illumination unit;
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.

According to the fifth aspect of the present invention, there is provided a vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying a first video whose light source is the first luminous flux emitted from the illumination unit and a second video whose light source is the second luminous flux, respectively, in a time divisional manner by means of raster scanning; and
a display mode switching unit to switch between a multiple video display mode in which the transmission-type display element displays the first video and second video in a time divisional manner and a single video display mode in which the transmission-type display element displays any one of the first video and the second video.
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing one use example of a video display apparatus according to the present invention;

FIG. 2 is a view showing a basic configuration of the video display apparatus according to the present invention;

FIG. 3 is a view showing a specific configuration of the video display apparatus according to the present invention;

FIG. 4 is a view showing another specific configuration of the video display apparatus according to the present invention;

FIG. 5 is a view showing another specific configuration of the video display apparatus according to the present invention;

FIGS. 6A to 6C are views showing one lens element of a lens array and a corresponding light source shown in FIG. 5;

FIG. 7 is a view showing a sectional structure of the configuration shown in FIG. 3, 4 or 5;

FIG. 8 is a view showing a modified example of FIG. 7;

FIGS. 9A and 9B are views each illustrating a time divisional driving of a first light source and a second light source according to the present embodiment;

FIGS. 10A and 10B are views each illustrating a scanning method using a display element;

FIG. 11 is a view showing a configuration in the case of considering a matrix shaped light source and a display element in a vertical raster scheme;

FIGS. 12A and 12B are views each showing how an appearance of a display screen based on the embodiment illustrated in FIG. 11 changes in accordance with an elapse of time;

FIG. 13 is a timing chart showing an appearance of a response of a target pixel and a light emitting timing of the first light source and the second light source;

FIGS. 14A and 14B are views each illustrating a dividing back light;

FIGS. 15A and 15B are views each showing a specific example for achieving the dividing back light;

FIG. 16 is a view showing a specific example of the video display apparatus;

FIGS. 17A and 17B are views each showing how specific polarization is output by turning ON or OFF cell A and cell B each configuring a liquid crystal cell 39;

FIG. 18 is a view showing another specific configuration of the video display apparatus;

FIGS. 19A and 19B are views each showing a specific example of a stripe-shaped light source which can be applied to the embodiment of FIG. 18;

FIG. 20 is a view showing an example of a multiple video display in a plurality of directions (three directions) as well as a multiple video display in two directions;

FIGS. 21A and 21B are functional block diagrams each depicting a video display apparatus according to the present invention;

FIGS. 22A to 22C are views each illustrating directivity features of a light source suitable to a vehicle-mounted multiple video display apparatus;

FIGS. 23A and 23B are views each illustrating a positional relationship between a lenticular or lens array and a light source;

FIG. 24 is a view showing an example in the case where the video display apparatus according to the present invention is mounted as a vehicle monitor; and

FIG. 25 is a view showing an example in the case where the present invention is applied to a three-dimensional display apparatus.

### DETAILED DESCRIPTION OF THE INVENTION

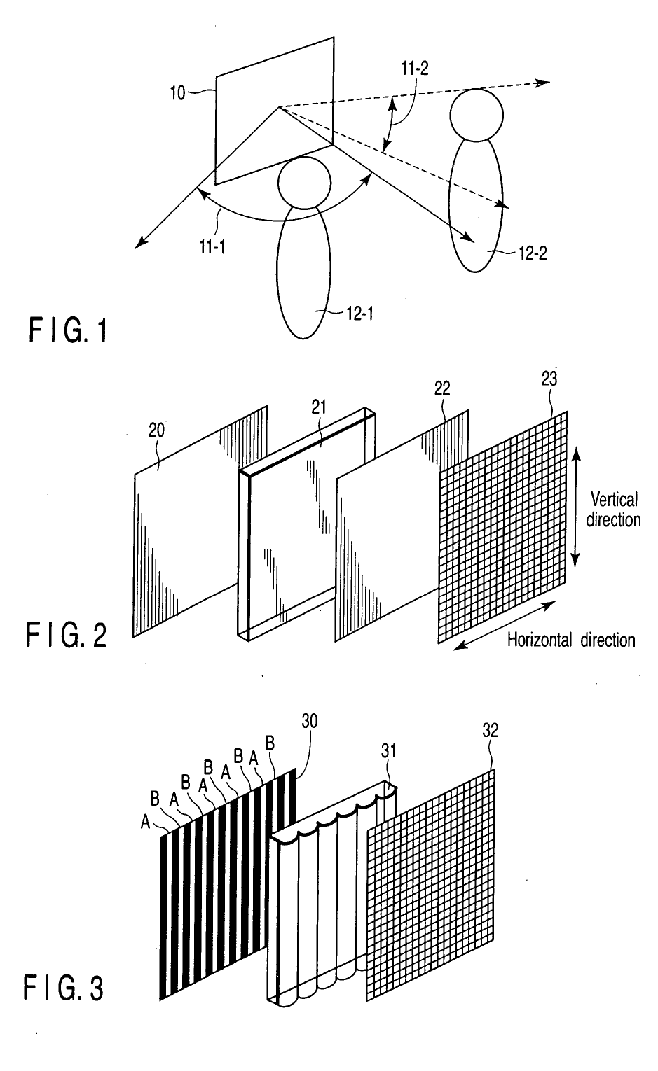

Hereinafter, preferred embodiments of the present invention will be described in detail with reference to the accompanying drawings. FIG. 1 is a view showing one use example of a video display apparatus according to the present invention. A first observer 12-1 who observes a display screen 10 is located in the right front of one display screen 10, and a second observer 12-2 who observes the display screen 10 is located in the left front of the display screen 10. The first observer 12-1 is located in a first video observing range 11-1 so that he/she can observe a first video (first luminous flux), and at the same time, the second observer 12-1 is located in a second video observing range 11-1 so that he/she can observe a second video (second luminous flux).

Here, in actuality, by means of raster scanning, the first video and the second video are displayed alternately in a first field and a second field of the display screen 10 in a time divisional manner. However, a display is changed at a high speed, and thus, the observer recognizes continuous videos, respectively, due to an afterimage effect of human eye.

FIG. 2 is a view showing a basic configuration of the video display apparatus according to the present invention, wherein a light emitting region dividing light source 20, a light directivity separating element 21, a light scattering element 22, and a transmission-type display element 23 such as an LCD are positioned in order. The light emitting region dividing light source 20 and the optical directory separating element 21 and/or light scattering element 22 configure an illuminating unit.

The light emitting region dividing light source 20 has its light emitting region divided into a plurality of regions, enabling ON/OFF driving with respect to each region. For example, a stripe-shaped light source utilizing a light guide, a matrix shaped light source having LEDs arranged thereon, or the like is available, although any element can be used as long as a light emitting area is segmented and a light emitting region can be changed in a time divisional manner.

The optical directory separating element 21 is an element which comprises directivity for output light beams emitted from respective regions of the light emitting region dividing light source 20 to another specific direction, respectively. Specific examples include, for example, a lenticular lens, a lens array, a diffracting element, a hologram element, a prism sheet and the like.

The light scattering element 22 is an element for reducing illumination non-uniformity, and any element is available as long as it scatters light. This element includes a scattering plate, a diffracting element, a prism sheet and the like. The light scattering element 22 is provided between the light directivity separating element 21 and the transmission-type display element 23 as illustrated, or alternatively, is provided between the light emitting region dividing light source 20 and the light directivity separating element 21. At this time, a video is separated so as to obtain two directivities in a horizontal direction. Thus, if scattering is too strong in the horizontal direction, two videos coexist, and there is a possibility that these two videos are seen as double videos. Therefore, it is preferable to use a light scattering element with a scattering feature in the horizontal direction which is smaller than that in the vertical direction.

FIG. 3 is a view showing a specific configuration of the video display apparatus according to the present invention. This display apparatus is composed of: a stripe-shaped light source 30 having a light emitting portion in a stripe shape; a lenticular lens 31 serving as a light directivity separating element for providing directivity to light from the stripe-shaped light source 30; and a transmission-type display element 32 for displaying a video.

The stripe-shaped light source 30 has two lines, a first light source (line A) and a second light source (line B) positioned alternately, and light beams are emitted on line A and line B alternately in a time divisional manner. When light beams are emitted on line A, directivity is provided by the lenticular lens 31, and illumination is provided only in a direction in which the first observer is located. In contrast, when light beams are emitted in line B, illumination is provided only in a direction in which the second observer is located. Therefore, during line A light emission and during line B light emission, videos displayed on the transmission-type display element 32 are produced as those which correspond to each other, whereby the first observer and the second observer can observe videos respectively individually.

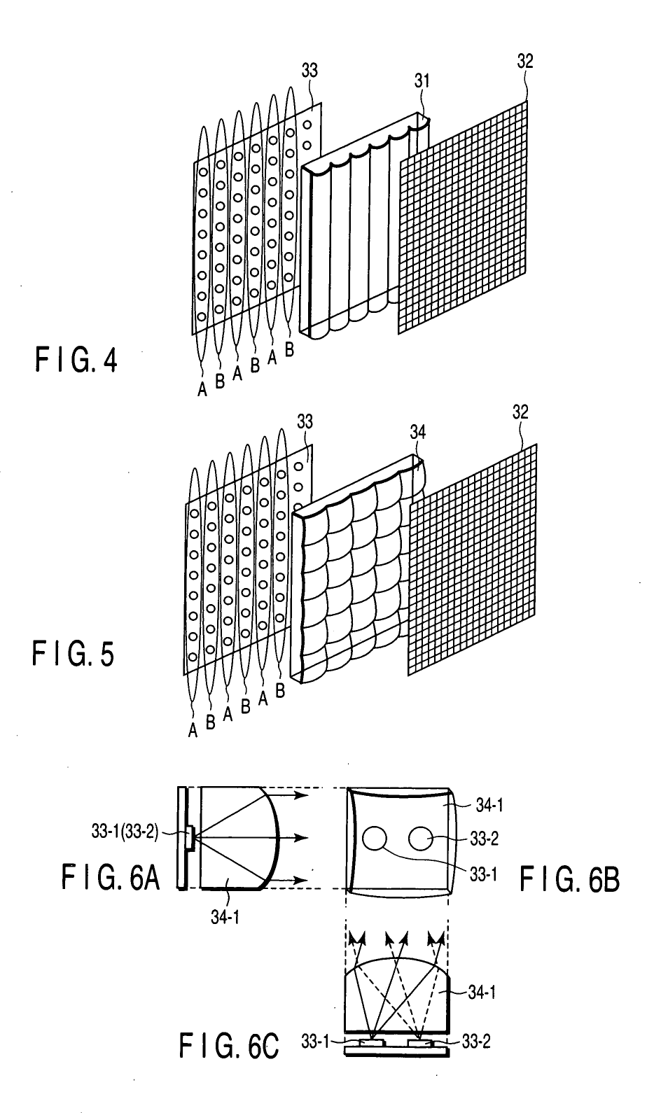

FIG. 4 is a view showing another specific configuration of the video display apparatus according to the present invention. The configurations of the lenticular lens 31 and transmission-type display element 32 are identical to those of the lenticular lens 31 and transmission-type display element 32 shown in FIG. 3. In FIG. 4, there is a difference in that a dot matrix shaped light source 32 positioned in a dot shape is provided as a light source instead of the stripe-shaped light source 30. As shown in the figure, light sources arranged in vertical one row are defined as the first light source (line A) and the second light source (line B).

FIG. 5 is a view showing another specific configuration of the video display apparatus according to the present invention. The configurations of the dot matrix shaped light source 33 and transmission-type display element 32 are identical those of the dot matrix shaped light source 33 and transmission-type display element 32 shown in FIG. 4. There is a difference in that the light directivity separating element is used as a lens array 34 instead of the lenticular lens 31. With the lens array 34, the directivity in the vertical direction as well as that in the horizontal direction can be adjusted. In particular, a sense of dot in the case where the dot matrix shaped light source 33 is used as a light source can be eliminated.

FIGS. 6A to 6C are views each showing one lens element 34-1 of the lens array 34 shown in FIG. 5 and a light source 33-1 (33-2) provided correspondingly. FIG. 6A is a sectional view in the vertical direction of FIG. 5; FIG. 6B is a front view; and FIG. 6C is a sectional view in the horizontal direction of FIG. 5. As is evident from the front view of FIG. 6B, two light sources 33-1 and 33-2 are positioned corresponding to one lens element 34-1.

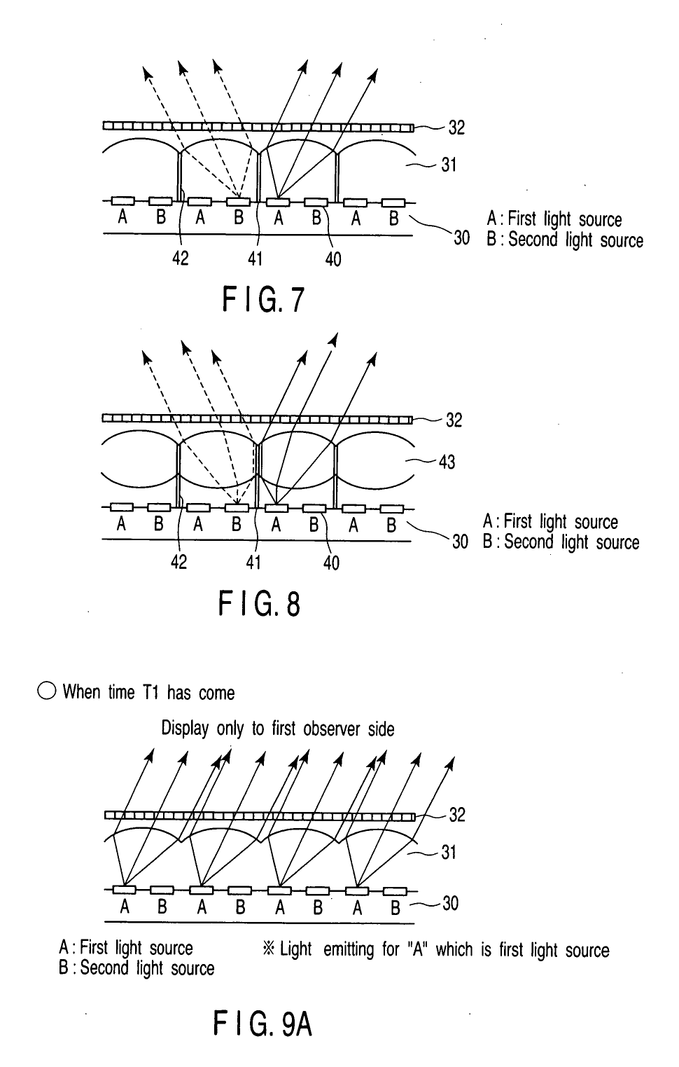

FIG. 7 is a view showing a sectional structure of the configuration shown in FIG. 3, 4 or 5. This structure is composed of the transmission-type display element 32, the lenticular lens 31 (or lens array 34), and the stripe-shaped light source 30 (or dot matrix shaped light source 33). For example, a liquid crystal display element or the like can be utilized as the transmission-type display element 32.

The stripe-shaped light source 30 is composed of line A which is a first light source and line B which is a second light source. Line A corresponds to the first observer, and line B corresponds to the second observer. On line A and line B, light beams are emitted in field units and frame units of display videos in a time divisional manner, and a display corresponding to this light emission is made by the transmission-type display element 32, whereby the video according to each of the first observer and second observer can be observed.

In FIG. 7, although the first light source (line A) and the second light source (line B) correspond to a light emitting portion 40, a material between the first light source and the second light source is composed of a light absorbing member, and configures a non-light emitting portion 41. A partition (partition wall) 42 is provided at the boundary portion of lens elements of the lenticular lens 31 (or lens array 34), whereby a crosstalk caused by stray light or the like can be reduced. A crosstalk can be further reduced when surface processing for absorbing light is applied onto a surface of the partition 42 or non-light emitting portion 41. The partition 42 may be composed of a reflection member.

FIG. 8 is a view showing a modified example of FIG. 7. FIG. 8 shows a sectional structure when a double-sided lenticular lens 43 is used instead of the lenticular lens 31. A double-sided lens array may be used instead of the double-sided lenticular lens 43.

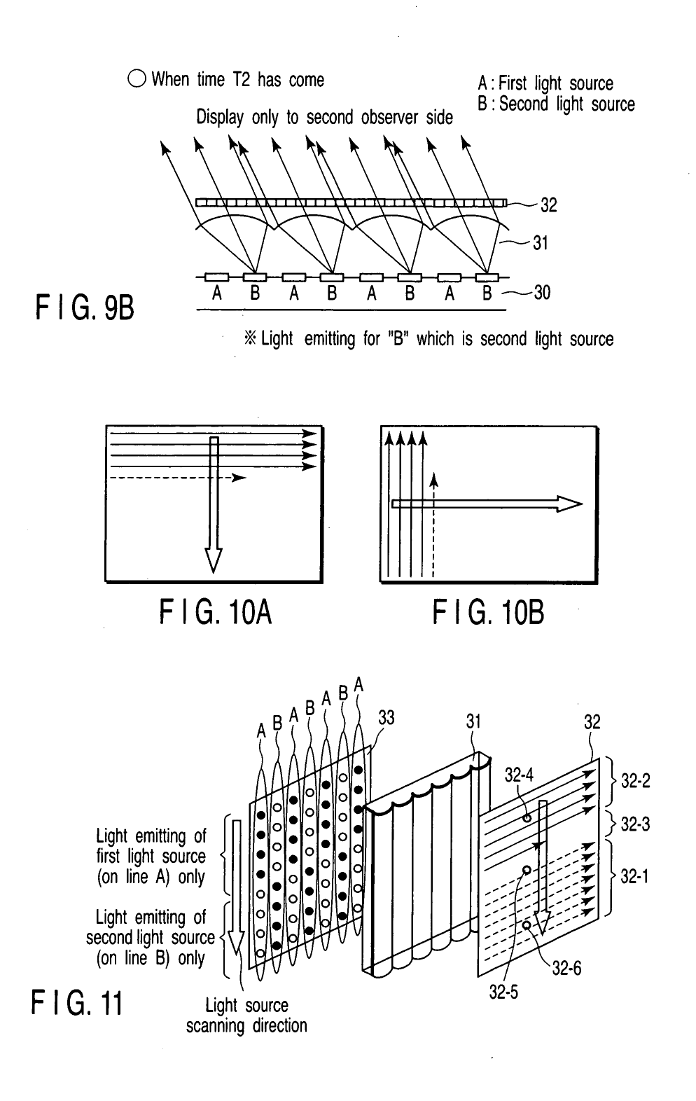

FIGS. 9A and 9B are views each illustrating a time divisional driving of the first light source and second light source according to the present embodiment. When a certain time T1 has come, as shown in FIG. 9A, only the line A light source which is the first light source, of the stripe-shaped light source 30, emits light, and the line B light source which is the second light source goes OFF. The line A light source has directivity provided by the lenticular lens 31, and illuminates only in the direction of the first observer. At this time, only the first observer can observe a video, and the transmission-type display element 32 displays a video for the first observer 1.

Next, when a certain time T2 has come, as shown in FIG. 9B, only the line B light source which is the second light source, of the stripe-shaped light source 30, emits light, and the line A light source which is the first light source goes OFF. The line B light source has directivity provided by the lenticular lens 31, and illuminates only in the direction of the second observer. At this time, only the second observer can observe a video, and the transmission-type display element 32 displays a video for the second observer.

Therefore, a state of time T1 and a state of time T2 are switched to each other at a high speed, whereby each of the observers can observe the video corresponding to each of the observers can be observed without interruption of the video.

FIGS. 10A and 10B are views each illustrating a scanning method using a display element. In general, a display element updates information on each of the pixels by scanning them sequentially. FIG. 10A shows a display element of such type which carries out raster scanning in the vertical direction of the screen. Information is updated on one line by line basis, and information on a full screen is updated by carrying out scanning in the vertical direction.

FIG. 10B shows a display element of such type which carries out raster scanning in the horizontal direction of the screen. Information is updated on a one line by line basis, and information on a full screen is updated by carrying out scanning in the horizontal direction.

Hereinafter, scanning of a matrix shaped light source and a display element (liquid crystal display element) in a vertical raster scheme, which is a feature of the present invention, will be described with reference to FIG. 11. Considering a liquid crystal display element generally used as a transmission-type display element, a display mode called a hold type is used. The hold type used here implies a scheme in which, for example, after new pixel information has been displayed in a certain pixel, light is always emitted during a remaining period of time for next pixel information to be displayed. In contrast, a CRT monitor or the like is called an impulse type. Referring to a certain pixel, light beams are emitted momentarily as compared with a 1-field period of time.

A liquid crystal display element is of hold type, and thus, when fields each are sequentially displayed by raster scanning, an old field display region and a new field display region exist on one screen, and a portion falling under the boundary portion of respective fields moves along with the scanning direction. Consequently, if a screen is uniformed, and only the first light source for the first observer emits light, a crosstalk occurs.

In the present embodiment, the first light source and the second light source are switched to each other in synchronism with movement of a boundary portion 32-3 between a first video in a first video display region 32-1 and a second video in a second video display region 32-2, in the display screen of the transmission-type display element 32 according to the vertical raster scheme. According to such a method, even if a video for the first observer and that for the second observer coexist in the same screen, no crosstalk occurs.

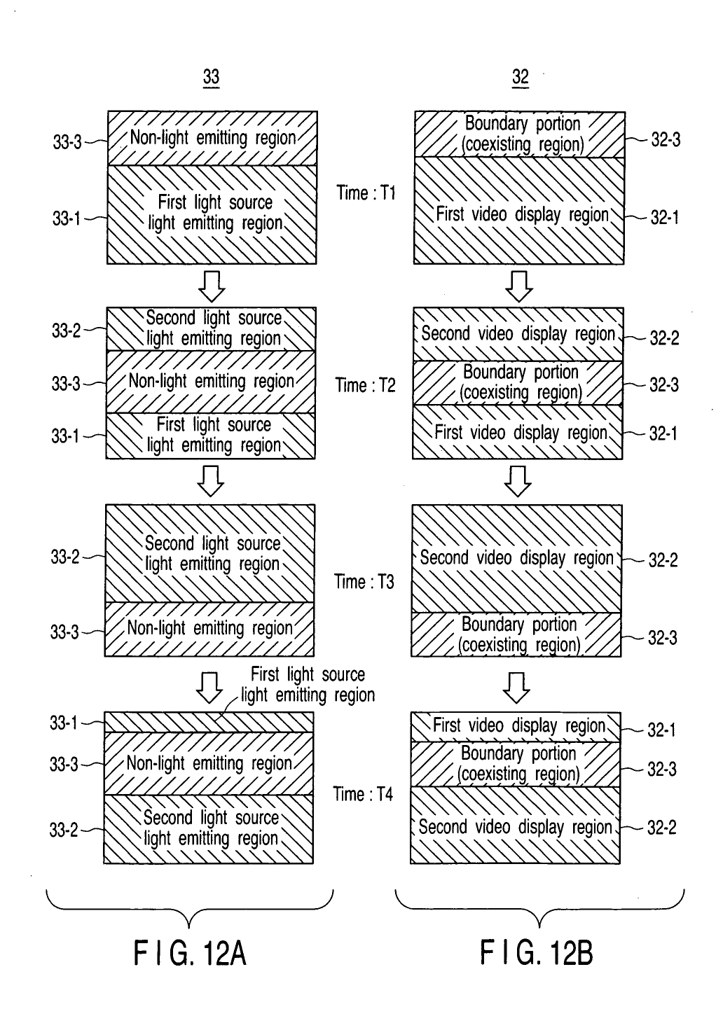

Now, another feature of the present invention will be described here. FIGS. 12A and 12B each show an appearance of the dot matrix shaped light source 33 and the transmission-type display element 32 in each of times T1, T2, T3 and T4, and time elapses in ascending order of T1→T2→T3→T4.

In a region of the dot matrix shaped light source 33 which serves as a back light, there exist: a light emitting region 33-1 caused by the first light source; a light emitting region 33-2 caused by the second light source; and a non-light emitting region 33-3. In addition, the first video display region 32-1, the second video display region 32-2, and the boundary portion (coexisting region) 32-2 exist on the display screen of the transmission-type display element 32. The present invention is featured in that the non-light emitting region 33-3 exists in the region of the dot matrix shaped light 33 corresponding to the boundary portion (coexisting region) of the transmission-type display element 32. Now, a description of this feature will be given here.

A general display apparatus merely displays one video. For example, even if an N-th frame image and an N+1-th frame image are switched to each other, a difference between these N-th and N+1-th images is small. Thus, even if the light source always is ON, such a difference can be hardly recognized, and a phenomenon that a contour blurs in a video including a quick motion can only be seen.

However, in a multiple screen video display apparatus according to the present invention, a video according to each of two directions is displayed. For example, in the case where the N-th frame video is the first video for the first observer, and the N+1-th video is the second video for the second observer, completely different images are displayed between the N-th and N+1-th images.

Consider a liquid crystal display element which is mainly used as a current transmission-type display element. The liquid crystal display element uses a hold mode display scheme and is not sufficiently quick in response speed. Accordingly, it takes long to switch a first video to a second video which is different from the first video, and an intermediate video between the first video and the second video is displayed at the boundary portion which is in the middle of the change. Namely, if a back light always turns ON or if the first light source is switched to the second light source momentarily, an intermediate portion between the two videos is also seen. This phenomenon causes a crosstalk.

In the present embodiment, therefore, in accordance with the boundary portion between the first video and the second video, a non-light emitting region (a period in which a light source is not turned ON) is provided during a period for switching the first light source to the second light source, thereby eliminating a display of a portion at which an intermediate video between the two videos is produced.

In order to obtain a good image quality, it is desirable that the non-light emitting region 33-3 is larger than a region in which the first video display region 32-1 and the second video display region 32-2 coexist.

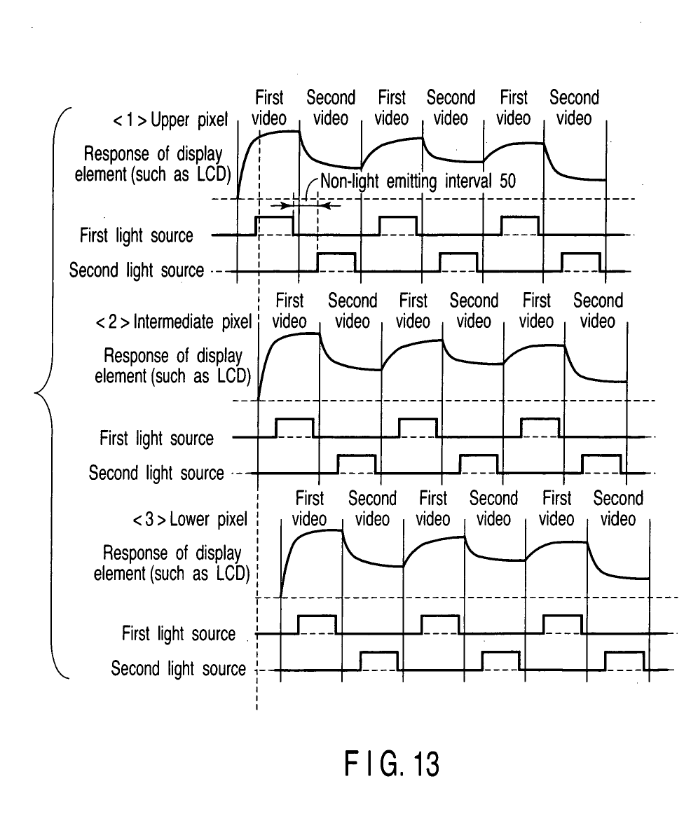

Now, a description will be given with respect to pixels located at three points, an upper point 32-4, a center point 32-5, and a lower point 32-6 on the display screen of the transmission-type display element 32. FIG. 13 is a timing chart showing an appearance of a response of a target pixel and a light emitting timing of the first light source and second light source. A horizontal axis indicates a time, and a vertical axis indicates an appearance of a response (display tone) (in the case of display element 32) and an appearance of light emitting and non-light emitting of the first and second light sources. This figure assumes use of a liquid crystal display element, and thus, shows an appearance of a remaining response for a target gradation to reach. It is evident that the first video and the second video are displayed alternately on each of the upper, middle, and lower pixels. Concurrently, this figure shows a light emitting timing of the first light source and the second light source. A portion designated by reference numeral 50 is a non-light emitting interval corresponding to the non-light emitting region 33-3 described in FIG. 12A.

Further, the boundary portion 32-3 between the first video display region 32-1 and the second video display region 32-2 of the display element 32 is scanned, and is updated on a full screen, and therefore, it is evident that a timing is shifted depending on a screen location. In this manner, a light emitting timing is adjusted depending on the screen location, thereby making it possible to display a video with a small amount of crosstalk in the case where the two different videos has been displayed.

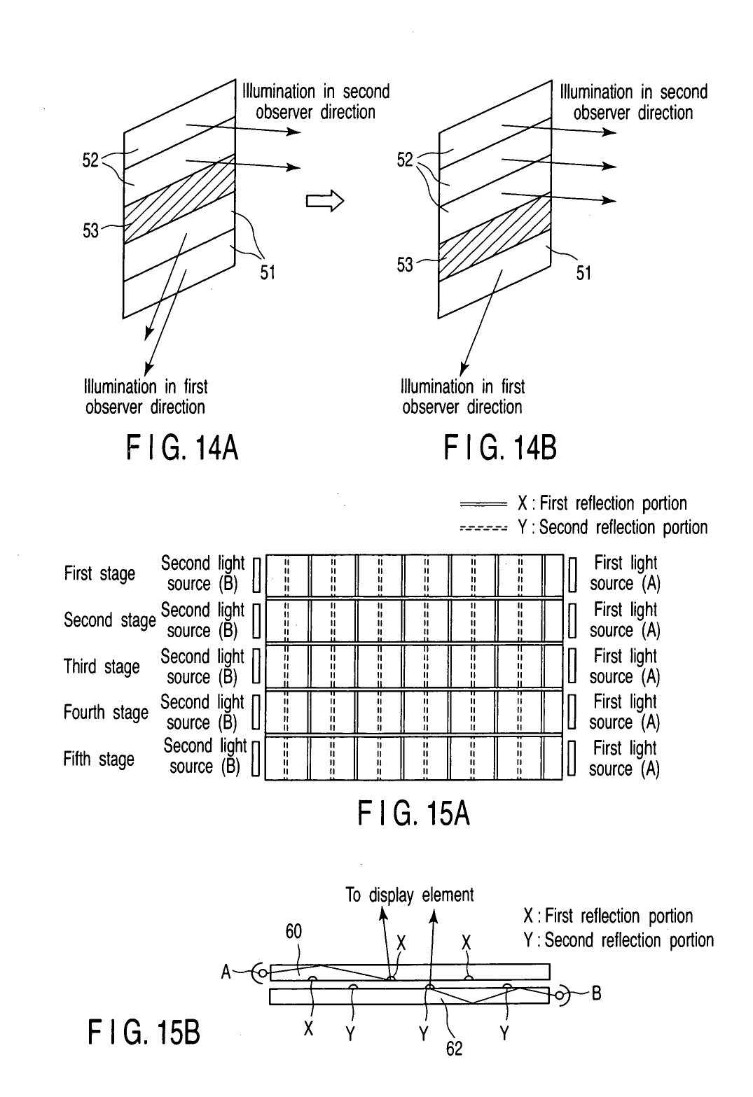

FIGS. 14A and 14B are views each illustrating a dividing back light. When the back light is driven in accordance with the method as described in FIG. 12, a method for dividing and driving a display screen is used as a simplified method. The back light is divided into 5 sections, and illumination for the first video, illumination for the second video, no-illumination or the like can be controlled with respect to each of the regions. In FIG. 14A, of the regions divided into 5 sections, a second light source light emitting portion 52 is positioned in the upper two regions; a non-illumination portion 53 is positioned at the center; and a light source light emitting portion 51 is positioned in the lower two regions. After a predetermined time has elapsed, as shown in FIG. 14B, there is shown that the upper three regions have been switched to the second light source light emitting portion; the second lowest region has been switched to the non-light emitting portion; and the first light source light emitting portion 51 has been switched to the lower two regions.

Hereinafter, a description will be given with respect to a specific configuration for achieving a dividing back light described in FIGS. 14A and 14B. As shown in FIGS. 15A and 15B, a first reflection portion “X” is provided at a first light guide 60 of the first light source A, and a second reflection portion “Y” is provided at a second light guide portion 62 of the second light source B.

In a sectional structure of FIG. 15B, the light emitted from the first light source A transmits the inside of the first light guide 60. However, the emitted light is reflected at the groove shaped reflection portion “X”, whereby a full reflection condition for the light from the first light source A breaks. The reflected light is emitted to the outside of the first light guide 60, and reaches a display element. Further, the light emitted from the second light source B transmits the inside of the second light guide 62. However, the emitted light is reflected at the protrusion shaped reflection portion “Y”, whereby a full reflection condition for the light from the second light source B breaks. The reflected light is emitted to the outside of the second light guide 62, and reaches a display element.

Therefore, the position of a light emitting line can be changed by switching the first light source A and the second light source B to each other. A light directory separating element such a lenticular lens is combined with this light source, thereby making it possible to differentiate the light emitting direction. In this manner, a back light for a multiple screen display apparatus which is compatible with vertical screen scanning can be provided.

As shown in FIG. 14A, since the light source is vertically divided into 5 sections, it is possible to control in which of the directions the light beams are emitted or turned OFF at respective stages.

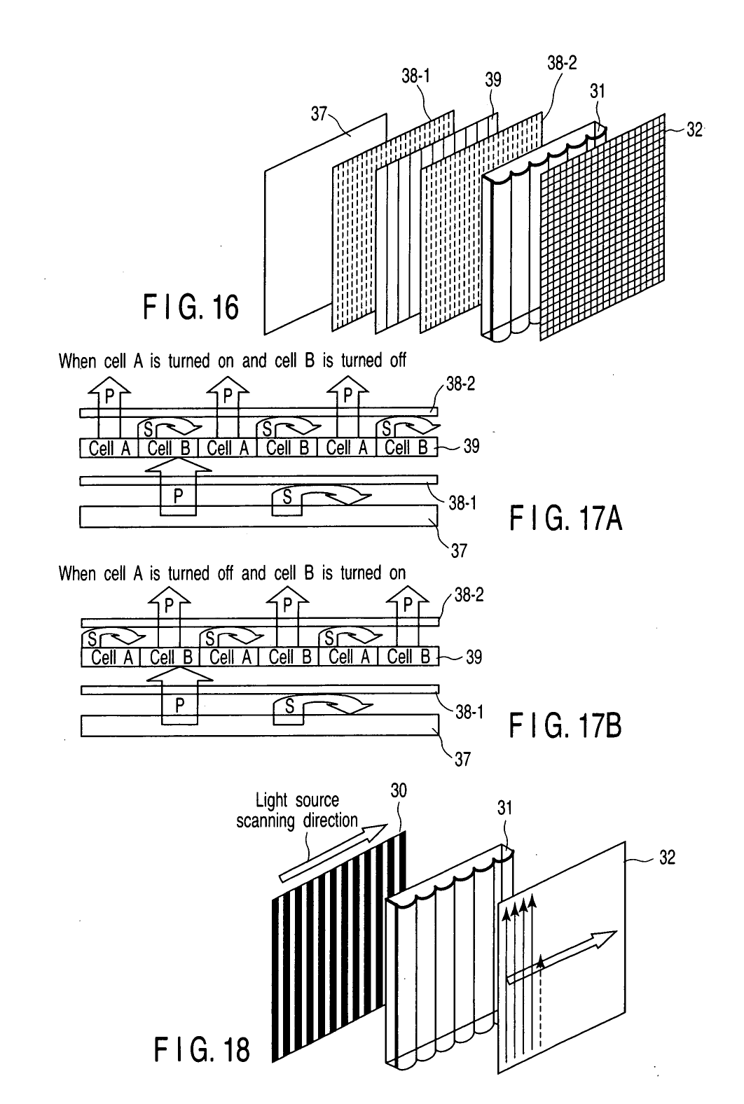

FIG. 16 is a view showing a specific example of the video display apparatus, wherein a planer light source 37, a polarization separating/reflecting sheet 38-1, a liquid crystal cell 39, a polarization separating/reflecting sheet 38-2, a lenticular lens 31, and a transmission-type display device 32 are positioned in order.

A liquid crystal cell 39 is composed of a liquid crystal shutter having a stripe structure or a matrix structure. Such a liquid crystal shutter is positioned on the light source side to control line light emission or matrix light emission.

The liquid crystal cell 39 enables ON/OFF operation by means of electric control. In the ON state, incident light passes without rotation in a polarization direction. In the OFF state, the polarization direction of incident light rotates by 90 degrees. For example, the incident light of polarization P is emitted as polarization S. In the present embodiment, utilizing such a property of the liquid crystal cell 39, a transmission region and an non-transmission region are formed by means of the ON/OFF operation for cells (cell A and cell B) of the liquid crystal cells 39 so as to emit a first luminous flux and a second luminous flux in a time divisional manner.

Further, as shown in FIG. 16, the liquid crystal cell 39 is configured to be sandwiched between the two polarization separating/reflecting sheets 38-1 and 38-2, thereby controlling a line light source or a matrix light source. The polarization separating/reflecting sheets 38-1 and 38-2 are used to enhance light use efficiency. For example, these sheets each have a property that polarization P is transmitted, but polarization S is reflected. Polarization S which cannot be transmitted and which has not been utilized returns to the illumination side, and the polarization is deformed by scattering, reflection and the like. These sheets are reused when polarization P partially occurs. A polarization plate may be used instead of the polarization separating/reflecting sheet 38-1.

FIGS. 17A and 17B each show how specific polarization is output by an operation for turning ON/OFF cell A and cell B each configuring the liquid crystal cell 39. Only polarization P of the light beams emitted from the planar light source 37 is passed on the first polarization separating/reflecting sheet 38-1, and polarization S is returned. Although the passed polarization P is incident upon the liquid crystal cell 39, if a region (cell A or cell B) of the incident liquid crystal is turned ON, polarization P is passed. If the region is turned OFF, polarization S is passed. For example, in the case where cell A is turned ON and cell B is turned OFF (FIG. 17A), polarization P is output only from cell A of the liquid crystal cell 39. When cell A is turned OFF and cell B is turned ON (FIG. 17B), polarization P is output only from cell B of the liquid crystal cell 39.

Next, polarization P is transmitted by the polarization separating/reflecting sheet 38-2, and polarization S is reflected. Light can be transmitted in only the liquid crystal cell in an ON state.

A general polarization plate may be used instead of the polarization separating/reflecting sheet. However, in this case, a light loss is large. In addition, an embodiment in which functions of polarizations P and S are replaced with each other is also possible.

FIG. 18 is a view showing another specific configuration of a video display apparatus, wherein a stripe-shaped light source 30 in a vertical direction, a lenticular lens 31, and a transmission-type display element 32 in a horizontal raster scheme are positioned in order. This configuration is featured in that the stripe-shaped light source 30 and the transmission-type display element 32 in a horizontal raster scheme are combined with each other. At this time, lines of the stripe-shaped light source 30 are used as those which enables turning ON/OFF independently.

A description will be given here with respect to the transmission-type display element 32 in a horizontal raster scheme. In the configuration described in FIG. 11, the transmission-type display element 32 is in a vertical raster scheme. Thus, in addition to switch of a horizontal location of a light emitting portion including a first light source and a second light source, a switch of a vertical location of the light emitting portion must be made in synchronism with the vertical raster direction. However, in the present embodiment, the transmission-type display element 32 is in a horizontal raster scheme. Therefore, the switch of the horizontal locations of the first light source is identical to that of the horizontal location of the light emitting portion in synchronism with the horizontal raster direction in the position switching direction. As long as an illumination can turn ON/OFF light emission independently in each of the light emitting lines, it is possible to produce illumination corresponding to raster scanning of a display element.

In a method for driving light emission, first, light beams are driven to be sequentially emitted from the left side only in line A which is the first light source in synchronism with raster scanning of a first video. Next, the first light source goes OFF in synchronism with a second video being scanned from the left, and the second light source is driven so as to emit light. As in FIG. 11, a crosstalk can be reduced by switching the first light source and second light source to each other in synchronism with movement of the boundary portion between the first video and the second video. In this case, the movement direction of the boundary portion is substantially parallel to a horizontal direction, i.e., a line segment connecting a position of observing the first video and a position of observing the second video. Further, both of the light sources may be turned OFF at the boundary portion.

In the configuration according to the present embodiment, a switching unit in the vertical direction of a light emitting position is eliminated as compared in FIG. 11. A light source light emitting drive unit can be configured to be simple as compared with that shown in FIG. 11. As a result, the object of the present invention can be efficiently achieved, and cost saving can be achieved.

Now, an operation of the configuration in FIG. 18 will be described here. With raster scanning of the first video, light beams are emitted from the light source A which is the light source in order from a portion falling under the left side of the screen. Next, with raster scanning of the second video, the light sources are turned OFF in order from the left side of the screen. At the same time, light beams are emitted from the light source B which is the second light source in order from the left of the screen. Then, with raster scanning of a next first video, the light sources go OFF in order from the left of the screen. By repeating this operation, displayed videos can be distributed to the first and second observers, and scanning of the display screen can be carried out.

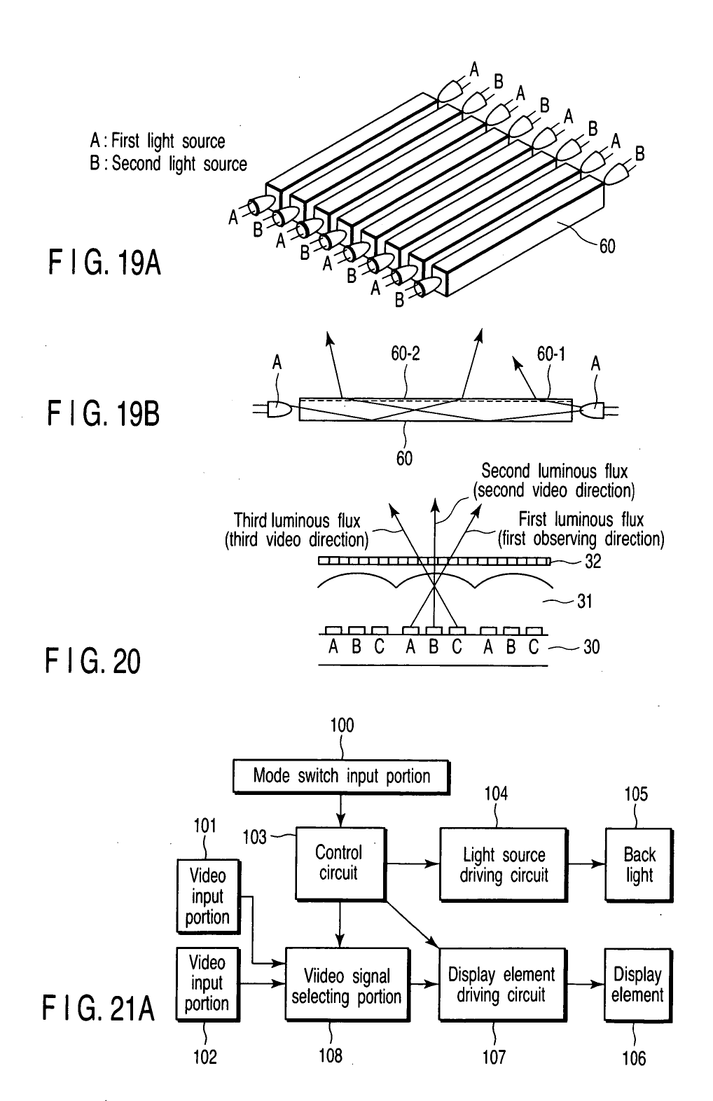

FIGS. 19A and 19B each show a specific example of a stripe-shaped light source which can be applied to the embodiment of FIG. 18. The embodied invention is directed to a stripe-shaped light source, and is featured in that ON/OFF operation can be further controlled on a line by line basis. With this configuration, columnar light guides 60 are arranged in number of light sources, and light sources are positioned at one end or both ends of each light guide 60. That is, for the first light source A, light guides 60 are positioned in number of the first light sources A, thereby configuring a first light guide portion group. In addition, for the second light source B, light guides 60 are positioned in number of the second light sources B, thereby configuring a second light guide portion group.

With such a configuration, light beams can be emitted from only the light source A which is the first light source or light beams can be emitted from only the light source B which is the second light source. Further, light beams can be emitted in order from a light source at an edge according screen scanning.

FIG. 19B shows a cross section of the light guide 60. Any light source is available as long as it is a light emitting body such as an LED. A glass, a resin or the like is generally utilized for the light guide 60. Only an emission face 60-1 of the light guide 60 is sand-grained, and a plurality of reflector portions 60-2 such as protrusion are provided, whereby a full reflection condition for the light from the light source breaks so that light beams are emitted to the outside of the light guide 60.

FIG. 20 shows an example of a multiple video display in a plurality of directions (three directions in this case) as well as a multiple video display in two directions. Since three light sources (A, B, C) corresponding to each lens are provided, when each of these light sources emits light, it becomes possible to carry out observation only in the corresponding viewing direction.

In a use example, in the case where an attempt is made to carry out observation in 2 directions, a combination of the first light source A and second light source B, a combination of the first light source A and the third light source C, a combination of the second light source B and the third light source C, and the like are used, and a video corresponding to each of these combinations is displayed. For example, it is considered that a combination of A and B, a combination of B and C, or a combination of B and C may be displayed, or alternatively, A, B, or C may be displayed alternately.

In addition, in the case where an attempt is made to carry out observation in three directions, the first light source (A), the second light source B), and the third light source (C) are utilized, and the corresponding first video, second video, and third video are displayed at the same time. In this case, the first video, second video, and third video may be same or may be different from one another.

In the case where a single person attempts to carry out observation in a front face of a screen, only the second light source (B) located in the vicinity of the center of each lens such as a lenticular lens is utilized or all the light sources (A), (B), and (C) are turned ON at the same time, and a single video is displayed, thereby making it possible to achieve this attempt.

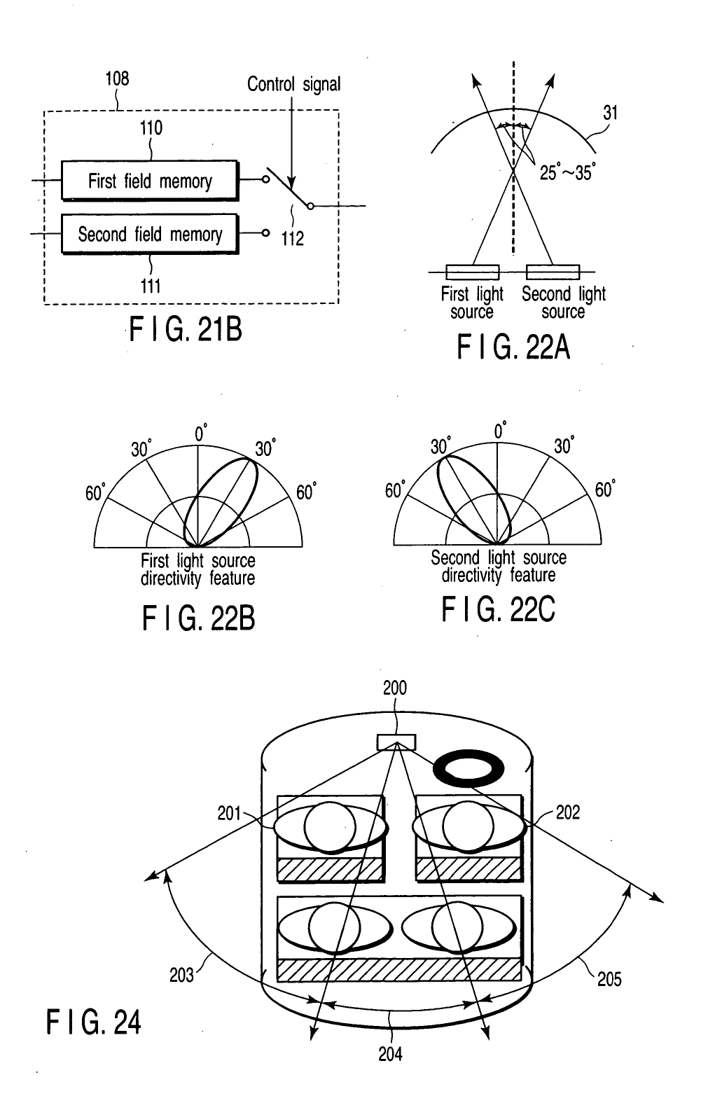

FIGS. 21A and 21B are functional block diagrams each depicting a video display apparatus according to the present invention. First, two video signals are input to a video signal selecting portion 108 via video input portions 101 and 102. Then, any one of these signals is selected, and is input to a display element driving circuit 107, whereby a display element 106 is driven. FIG. 21B shows an example of a configuration of the video signal selecting portion 108. The video signal input from the video input portion 101 is stored in a first field memory 110. In addition, the video signal from the video input portion 102 is stored in a second field memory 111. A switch 112 is switched over by a control signal from a control circuit 103. Then, the video signal from the first field memory 110 or the second field memory 111 is selectively input to the display element driving circuit 107.

A light source driving circuit 104 emits light from the first light source if the video displayed on the display element 106 is a video for the first observer. This circuit controls a back light 105 so as to emit light from the second light source if the above video is for the second observer.

The above-described video signal selecting portion 108, display element driving circuit 107, and light source driving circuit 104 are controlled by the control circuit 103. The light source driving circuit 104 and the control circuit 103 configure an illumination switching unit.

A mode switch input portion 100 serving as a display mode switching unit is provided as a portion for switching an operating mode by mode switch due to a user operation. Operations for displaying only the first observer or displaying only the second observer; displaying the same video for the first and second observers; and displaying another video to the first and second observers can be made. Settings can be provided so as to switch an operating mode by software applications.

FIGS. 22A, 22B and 22C are views each illustrating directivity features of light sources suitable to a vehicle-mounted multiple video display apparatus. In a general display apparatus, a front direction is regarded as an optimal viewing position. However, as in the present invention, in a display apparatus for observing a plurality of videos according to a viewing direction, it is necessary to ensure that an optimal viewing position is not in a front direction, and the directions in the respective observing positions is an optimal viewing position. In particular, when observation is carried out in two directions, the directivities of the light sources (first light source and second light source) which correspond thereto are set within the range from 25 degrees to 35 degrees (in this case, the front direction is set to 0 degree), whereby brightness is increased in the respective observing positions, and visibility is improved. In addition, this setting is effective in reducing stray light.

FIG. 22B shows a directivity feature of the first light source, and FIG. 22C shows a directivity feature of the second light source. In these directivity feature graphs, a peak point of brightness is defined as 100%; a rate relevant to that brightness is defined by axially expressing a straight line going from a center to an outer periphery; an emission direction is defined by an angle with the front direction of the light source being 0 degree; and an angle distribution feature of brightness is defined. In the figures, as an example, such a light source having a 30-degree direction as a peak is positioned so that an angle feature is symmetrical to another in the first light source and the second light source.

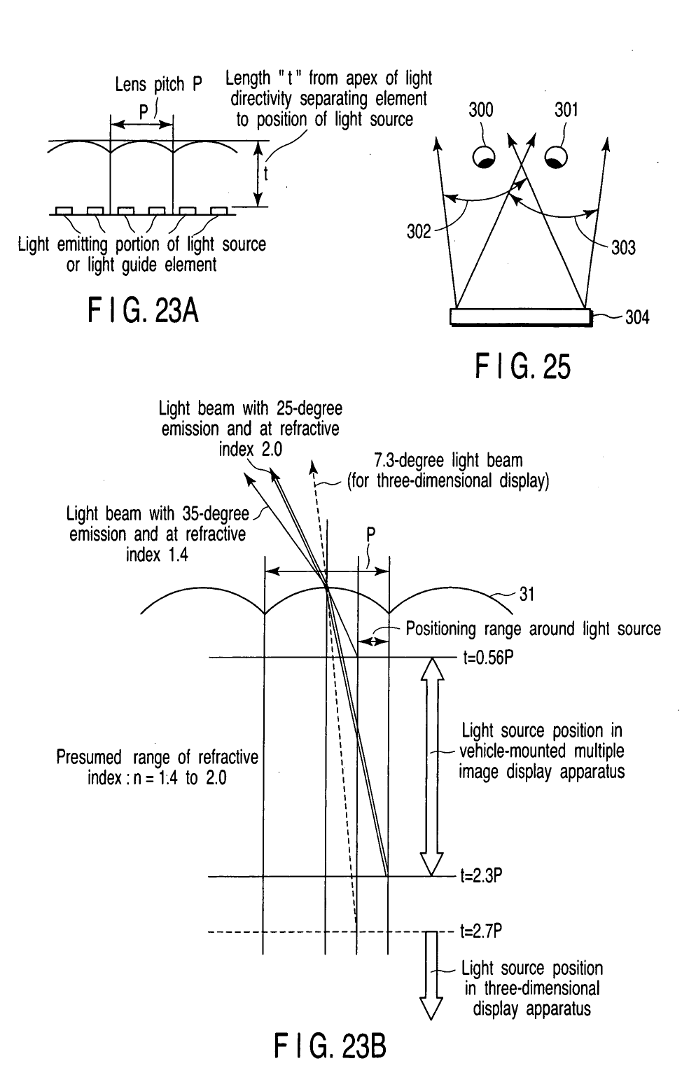

FIGS. 23A and 23B are views each illustrating a positional relationship between the lenticular lens or lens array and the light source.

The present invention is achieved by controlling directivity of a display video and a directivity of back light illumination. At this time, as, in particular, the vehicle-mounted multiple video display apparatus, in order to ensure that a main light beam from the light source is incident at an angle ranging from 25 degrees to 35 degrees in a normal direction of a display screen, a distance from an apex of the lenticular lens 31 (or lens array) serving as a light directivity separating element to the light source must have the following relationship.

In this relationship, a length of a lens pitch is defined as P, and a length from the lens apex to the light source is defined as “t”. The present embodiment shows a case in which an emission angle from the light source ranges from 25 degrees to 35 degrees, a lens refractive index is presumed to be within the range from 1.4 to 2.0, and the light beam in the lenticular lens 31 is placed in the most lying-down location most and in the most upright location. In addition, generally, the light source is positioned at a portion which is inward by ¼ pitch from the boundary of the lens relevant to the lens pitch. However, in order to maximize the emission angle, the light source may be positioned as close to the outside lens boundary as possible. Thus, it is presumed that the light source is placed in the range from inside 0P to ¼P from the lens boundary in the present embodiment. This is optimal in the case where the present invention is carried out for the vehicle-mounted multiple video display apparatus. The optimal length “t” from the lens apex to the light source is obtained in the following range through computation.
0.56P≦t≦2.3P
Namely, when the optimal length “t” is obtained as a three-dimensional display use, if there is established a condition that a viewing direction from a display screen is 250 mm or more, an eye width is about 64 mm, a lens refractive index is 1.4, and the length “t” is the shortest, a light beam of about 7.3 degrees is emitted, and is obtained as follows.
t≧2.7P

FIG. 24 shows an example in the case where the video display apparatus according to the present invention is mounted as a vehicle-mounted monitor.

A passenger's sheet is set in position of a first observer 201, and a driver's seat is set in position of a second observer 202, thereby making it possible to observe a video which corresponds to each of the passengers who take the passenger's seat and the driver. For example, while a car navigation video or a driving subsidiary video is provided to the driver, a variety of videos such as TV video, DVD video, game, or various information searches can be provided to the passenger who takes the passenger's seat at the same time. In this manner, even a video such as TV or cinema which is restricted in viewing while driving is provided only to the passenger's sheet, whereby, the passenger who takes the passenger's seat can enjoy a video such as TV or cinema even while a vehicle moves.

In addition, as shown in FIG. 20, a video can be provided to the back seat as well with a configuration in which a video can be provided in a front direction of a display screen.

FIG. 25 shows an example in the case where the present invention has been applied to a three-dimensional video display apparatus. A right eye 300 is set in a first observing position, and a left eye 301 is set in a second observing position, with respect to a display screen 304. A right eye parallax image is presented as a right eye video 302, and a left eye parallax image is presented as a left eye video 303, thereby making it possible to observe a three-dimensional video.

According to the present invention, there is provided a video display apparatus reducing a crosstalk of each of the videos.

(Additional Description)

The inventions having the following configurations are excerpted from the above-described specific embodiments. (Configurations 1 to 13 are associated with a three-dimensional video display apparatus.)

1. A video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
an illumination switching unit which sequentially switches the two light fluxes emitted from the illumination unit in synchronism with movement of a boundary portion between the first video and the second video in the display screen of the transmission-type display element.
   Corresponding figures: At least FIGS. 1, 2, 11, 12A, 12B and 13
   Function: Illumination directivities are sequentially switched in synchronism with movement of a boundary portion between a first video and a second video caused by raster scanning of a transmission-type display element.
   Advantage: A crosstalk of each of the videos is reduced.

For example, an illumination unit is composed of: a light emitting region dividing light source 20 and a light directivity separating element 21 and/or a light scattering element 22 in an embodiment. In addition, for example, an illumination switching unit is composed of a control circuit 103 and a light source driving circuit 104 in an embodiment.

2. A video display apparatus according to constitution 1, wherein the illumination unit includes:
a light source capable of selectively emitting light beam in a time divisional manner for each light emitting region divided into a plurality of regions; and
an optical element which emits in at least two different directions the first luminous flux and the second luminous flux selectively emitted as light beams in a time divisional manner from the light source, respectively.
   Corresponding figures: At least FIGS. 7, 8, 9A 9B, 10A and 10B
   Function: A light source and an optical element segmented on a region by region basis are combined with each other, and light beams are selectively emitted from the light source.
   Advantage: Illumination directivity can be switched by turning ON/OFF the light source on a region by region basis.

3. A video display apparatus according to constitution 1, wherein the illumination switching unit controls the illumination unit so as not to illuminate a region corresponding to the boundary portion.

Corresponding figures: At least FIGS. 12A, 12B, 13, 14A and 14B

Function: A region corresponding to a boundary portion in which a half tone between a first video and a second video is produced is disabled from illumination.

Advantage: A crosstalk is reduced.

4. A video display apparatus according to constitution 1, wherein the movement direction of the boundary portion between the first video and the second video, in the transmission-type display element, is substantially parallel to a line segment connecting an observing position of the first video and an observing position of the second video.

Corresponding figures: At least FIG. 18

Function: A boundary portion movement direction is horizontal.

Advantage: The above configurations 1 to 3 can be provided more simply.

5. A video display apparatus according to constitution 1, wherein the first video and the second video are identical to each other.

Corresponding figures: At least FIG. 20

Function: A first video and a second video are identical to each other.

Advantage: The same video can be seen by a first observer and a second observer.

6. A video display apparatus according to constitution 1, wherein the first video and the second video are different from each other.

Corresponding figures: At least FIG. 20

Function: A first video and a second video are different from each other.

Advantage: Different videos can be seen by a first observer and a second observer.

7. A video display apparatus according to constitution 1, wherein a light scattering element is positioned between the illumination unit and the transmission-type display element, and a scattering property of the light scattering element in a direction substantially parallel to a line segment connecting a first observer who observes the first video and a second observer who observes the second video is small as compared with a scattering property of the light scattering element in a direction substantially vertical to the line segment.

Corresponding figures: At least FIG. 2

Function: A scattering feature in a horizontal direction of a light scattering element used between an illumination and a display element is small as compared with that a vertical direction.

Advantage: An image quality is improved with a possible increase of scattering. However, large scattering in the horizontal direction causes a crosstalk. With the above configuration, a crosstalk can be reduced while an image quality is improved.

8. A video display apparatus according to constitution 2, wherein the light source include a light source having a plurality of light emitting regions composed of a plurality of light emitting elements arranged in a matrix shape or strip shape, and
the optical element includes a light directivity separating element for providing directivity in a direction different depending on a position of the light emitting region.
   Corresponding figures: At least FIGS. 3, 4 and 5
   Function: A light source is composed of a matrix-shaped or stripe-shaped light source and a light directivity separating element.
   Advantage: An illumination with selectable different directivities can be obtained.

9. A video display apparatus according to constitution 8, wherein the optical directivity separating element is composed of a lenticular lens or a lens array having a periodic structure, and
there exist the at least two or more light emitting regions corresponding to a lens for each period.
   Corresponding figures: At least FIGS. 3, 4, 5, 6A, 6B, 6C, 7, 8, 9A and 9B
   Function: A light directivity separating element is composed of a lenticular lens or a lens array. Two or more light emitting regions corresponding to each lens exist.
   Advantage: An illumination with selectable two or more directivities can be obtained.

10. A video display apparatus according to constitution 9, wherein the lenticular lens or one lens in the lens array and the two light emitting regions corresponding to the one lens are partitioned from another adjacent one lens and the two light emitting regions corresponding to the another lens via a partition wall.

Corresponding figures: At least FIGS. 7 and 8

Function: A lenticular lens or each of lenses in a lens array including a light emitting region is partitioned with a partition wall.

Advantage: A crosstalk can be reduced by reducing stray light.

11. A video display apparatus according to constitution 2, wherein the light source includes:
first and second light source groups composed of a plurality of light emitting elements; and
first and second light guide portion groups which separately guide luminous fluxes from the first and second light source groups,
a first emitting portion having emitted therefrom the first luminous flux provided for each first light guide portion in the first light guide portion group and a second emitting portion having emitted therefrom the second luminous flux provided for each second light guide portion in the second light guide portion group are positioned alternately in a direction which is substantially parallel to a line segment connecting a first observer who observes the first video and a second observer who observes the second video, and
the optical element includes a light directivity separating element for providing directivity of a direction which is different depending on a position between the first emitting portion and the second emitting portion.
   Corresponding figures: At least FIGS. 19A and 19B
   Function: A first light source illuminates a first observer via a light directivity separating element by a first light guide portion, and illuminates a second observer via a light directivity separating element by a second light guide portion. In addition, the emission portions of the first light guide portion and second light guide portion are positioned alternately in a horizontal direction.
   Advantage: An illumination having selectable two or more directivities can be achieved at a low cost.

12. A video display apparatus according to constitution 1, wherein the illumination unit includes:
a planar light source; and
a liquid crystal cell positioned on the planar light source and partitioned in a matrix shape or stripe shape sandwiched between two polarization plates or polarization separating/reflecting sheets, and
a transmission region and a non-transmission region are formed by an ON/OFF operation for each cell of the liquid crystal cells so as to emit the first luminous flux and the second luminous flux in a time divisional manner.
   Corresponding figures: At least FIGS. 16, 17A and 17B
   Function: An illumination is composed of a matrix shaped or stripe-shaped liquid crystal cell sandwiched between polarization plates or polarization separating/reflecting sheets.
   Advantage: A simple configuration using a conventional planar light source can be provided.

13. A video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
a display mode switching unit to switch between a multiple video display mode in which the transmission-type display element displays the first video and second video in a time divisional manner and a single video display mode in which the transmission-type display element displays any one of the first video and the second video.
   Corresponding figures: At least FIGS. 21A and 21B
   Function: A display mode switching unit is provided for changing a multiple video display mode and a single video display mode.
   Advantage: A multiple video display mode and a single video display mode can be switched according to a use scene.
   (Configurations 14 to 23 are Associated with a Three-Dimensional Video Display Apparatus.)

14. A three-dimensional video display apparatus for inputting a corresponding parallax video into each of left and right eyes in one observer to display a three-dimensional video, the apparatus comprising:
an illumination unit which emits a first luminous flux and a second luminous in two directions which correspond to the left and right eyes in a time divisional manner;
a transmission-type display element capable of displaying respectively in a time divisional manner by means of raster scanning a first video whose light source is the first luminous flux and a second video whose light source is the second luminous flux, emitted from the illumination unit, the first video being input into the left eye and the second video being input into the right eye; and
an illumination switching unit which sequentially switches the two luminous fluxes emitted from the illumination unit in synchronism with movement of a boundary portion between the first video and the second video in a display screen of the transmission-type display element.
   Corresponding figures: At least FIGS. 1, 2, 11, 12A, 12B, 13 and 25
   Function: Illumination directivities are sequentially switched in synchronism with movement of a boundary portion between a first video and a second video caused by raster scanning of a transmission-type display element.
   Advantage: A crosstalk of left and right parallax videos can be reduced.

15. A three-dimensional video display apparatus according to constitution 14, wherein the illumination unit includes:
a light source capable of selectively emitting light beams in a time divisional manner for each light emitting region divided in a plurality of regions; and
an optical element which emits the first luminous flux and the second luminous flux selectively emitted in a time divisional manner from the light source in two directions which correspond to the left and right eyes, respectively.
   Corresponding figures: At least FIGS. 7, 8, 9A, 9B, 10A and 10B
   Function: A light source and an optical element segmented on a region by region basis are combined with each other, and light beams are selectively emitted from the light source.
   Advantage: Illumination directivity can be switched by turning ON/OFF the light source on a region by region basis.

16. A three-dimensional video display apparatus according to constitution 14, wherein the illumination switching unit controls the illumination unit so as not to illuminate a region corresponding to the boundary portion.

Corresponding figures: At least FIGS. 12A, 12B, 13, 14A and 14B

Function: A region corresponding to a boundary portion in which a half tone between a first video and a second video is produced disabled from illumination.

Advantage: A crosstalk is reduced.

17. A three-dimensional video display apparatus according to claim 14, wherein the movement direction of the boundary portion between the first video and the second video, in the transmission-type display element, is substantially parallel to a line segment connecting the left and right eyes.

Corresponding figures: At least FIGS. 17A and 17B

Function: A boundary portion movement direction is horizontal.

Advantage: The above configurations 1 to 3 can be provided more simply.

18. A three-dimensional video display apparatus according to constitution 14, wherein a light scattering element is positioned between the illumination unit and the transmission-type display element, and a scattering property of the light scattering element in a direction which is substantially parallel to the line segment connecting the left and right eye is small as compared with a scattering property of the light scattering element in a direction which is substantially vertical to the line segment.

Corresponding figures: At least FIG. 2

Function: A scattering feature in a horizontal direction of a light scattering element used between an illumination and a display element is small as compared with a vertical direction.

Advantage: An image quality is improved more with a possible increase of scattering. However, large scattering in the horizontal direction causes a crosstalk. With this configuration, a crosstalk can be reduced while improving an image quality.

19. A three-dimensional video display apparatus according to constitution 15, wherein the light source includes a light source having a plurality of light emitting regions composed of a plurality of light emitting elements arranged in a matrix shape or a stripe shape, and
the optimal element includes a light directory separating element for providing directivity in a direction which corresponds to the left and right eyes depending on a position of the light emitting region.
   Corresponding figures: At least FIGS. 3, 4 and 5
   Function: A light source is composed of a matrix shaped or stripe-shaped light source and a light directivity separating element.
   Advantage: An illumination with selectable different directivities can be obtained.

20. A three-dimensional video display apparatus according to constitution 19, wherein the light directivity separating element is composed of a lenticular lens or a lens array having a periodic structure, and
there exist the at least two light emitting regions corresponding to a lens for each period. Corresponding figures: At least FIGS. 3, 4, 5, 6A, 6B, 6C, 7, 8, 9A and 9B
   Function: A light directivity separating element is composed of a lenticular lens or a lens array, and two or more light emitting regions corresponding to each lens exist.
   Advantage: An illumination with two or more selectable, different directivities can be obtained.

21. A three-dimensional video display apparatus according to constitution 20, wherein the lenticular lens or one lens in the lens array and the two light emitting regions corresponding to the one lens are partitioned via a partition wall from another adjacent one lens and two light emitting regions corresponding to the another lens.

Corresponding figures: At least FIGS. 7 and 8

Function: A lenticular lens or each of lenses in a lens array including a light emitting region is partitioned with a partition wall.

Advantage: A crosstalk can be reduced by reducing stray light.

22. A three-dimensional video display apparatus according to constitution 14, wherein the light source includes:
first and second light source groups composed of a plurality of light emitting elements; and
first and second light guide portion groups which separately guide luminous fluxes from the first and second light source groups,
wherein a first emitting portion having emitted therefrom the first luminous flux provided for each first light guide portion in the first light guide portion group and a second emitting portion having emitted therefrom the second luminous flux provided for each second light guiding portion in the second light guiding portion group are positioned alternately in a direction which is substantially parallel to a line segment connecting the left and right eyes, and the optical element includes a light directory separating element for providing directivity in a direction which corresponds to the left and right eyes depending on a position between the first emitting portion and the second emitting portion.
   Corresponding figures: At least FIGS. 19A and 19B
   Function: A first light source illuminates a first observer via a light directivity separating element by means of a first light guide portion, and illuminates a second observer via a light directivity separating element by means of a second light guide portion. In addition, the emission portions of the first light guide portion and second light guide portion are positioned alternately in a horizontal direction. Advantage: An illumination having selectable two or more directivities can be achieved at a low cost.

23. A three-dimensional video display apparatus according to constitution 14, wherein the illumination unit includes:
a planar light source; and
a liquid crystal cell positioned on the planar light source and partitioned in a matrix shape or stripe shape sandwiched between two polarization plates or polarization separating/reflecting sheets,
   wherein a transmission region and a non-transmission region are formed by an ON/OFF operation with respect to each cell of the liquid crystal cells so as to emit the first luminous flux and the second luminous flux in a time divisional manner.
   Corresponding figures: At least FIGS. 16, 17A and 17B
   Function: An illumination is composed of a matrix shaped or stripe-shaped liquid crystal cell sandwiched between polarization plates or polarization separating/reflecting sheets.
   Advantage: A simple configuration using a conventional planar light source can be provided.
   (Configurations 24 to 37 are Associated with a Vehicle-Mounted Video Display Apparatus.)

24. A vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner; and
a transmission-type display element capable of displaying respectively in a time divisional manner a first video whose light source is the first luminous flux and a second video whose light source is the second luminous flux, emitted from the illumination unit;
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.
   Corresponding figures: At least FIGS. 1, 2 and 24
   Function: This configuration is composed of an illumination capable of switching directivity in a time divisional manner and a display element for switching a video in synchronism with the switch of directivity. A first luminous flux and a second luminous flux are set within the range of substantially 25 degrees to 35 degrees, respectively.
   Advantage: When a display face is positioned in front of the center of a front seat, the display face can be positioned so as to be the most visible at a driver's seat and a passenger's seat.

25. A vehicle-mounted video display apparatus according to constitution 24, further comprising:
an illumination switching unit which, when the transmission-type display element is a display element capable of displaying the first video and the second video in a time divisional manner by means of raster scanning, respectively, sequentially switches the two luminous fluxes emitted from the illumination unit in synchronism with movement of a boundary portion between the first video and the second video in a display screen of the transmission-type display element.
   Corresponding figures: At least FIGS. 12A, 12B and 13
   Function: When a time divisional manner display is made by a display element for carrying out raster scanning, an illumination for sequentially switching luminous fluxes is provided in synchronism with movement of a boundary portion of a first video and a second video.
   Advantage: A crosstalk can be reduced by providing an illumination capable of sequentially switching the luminous fluxes.

26. A three-dimensional video display apparatus according to constitution 25, wherein the illumination switching unit controls the illumination unit so as not to illuminate a region corresponding to the boundary portion.

Corresponding figures: At least FIGS. 12A, 12B, 13, 14A and 14B

Function: A boundary portion for switching videos is disabled from illumination.

Advantage: A crosstalk can be reduced by disabling from illumination a boundary portion at which a half tone between a first video and a second video is produced.

27. A vehicle-mounted video display apparatus according to constitution 24, wherein the illumination unit includes:
a light source capable of selectively emitting light beams in a time divisional manner for each light emitting region divided into a plurality of regions; and
an optical element which emits the first luminous flux and the second luminous flux selectively emitted as light beams in a time divisional manner from the light source toward the observer at the driver's seat side and the observer at the passenger's seat side, respectively.
   Corresponding figures: At least FIGS. 7, 8, 9A, 9B, 10A and 10B
   Function: An illumination is composed of a light source and an optical element capable of selectively emitting light beams in each light emitting region.
   Advantage: Selective illumination oriented to each of observing positions becomes possible.

28. A vehicle-mounted video display apparatus according to constitution 24, wherein the first video and the second video are identical to each other.

Corresponding figures: At least FIG. 20

Function: A first video and a second video are identical to each other.

Advantage: The same video can be observed in different observing positions.

29. A vehicle-mounted video display apparatus according to constitution 24, wherein the first video and the second video are different from each other.

Corresponding figures: At least FIG. 20

Function: A first video and a second video are different from each other.

Advantage: Different videos can be observed depending on observing positions.

30. A three-dimensional video display apparatus according to constitution 24, wherein a light scattering element is positioned between the illumination unit and the transmission-type display element, and a scattering property of the light scattering element in a direction substantially parallel to a line segment connecting the observer at the driver's seat side and the observer at the passenger's seat side is small as compared with a scattering property of the light scattering element in a direction substantially vertical to the line segment.

Corresponding figures: At least FIG. 2

Function: A scattering feature in a horizontal scattering element used between an illumination and a display element is small as compared with that in a vertical direction.

Advantage: An image quality is improved with a possible increase of scattering. However, large scattering in the horizontal direction causes a crosstalk. With the above configuration, a crosstalk can be reduced while an image quality is improved.

31. A vehicle-mounted video display apparatus according to constitution 27, wherein the light source includes a light source having a plurality light emitting regions composed of a plurality of light emitting elements arranged in a matrix shape or in a stripe shape, and
the optical element includes a light directivity separating element for providing directivity in two directions between the observer at the driver's seat side and the observer at the passenger's seat side depending on a position of the light emitting region.
   Corresponding figures: At least FIGS. 3, 4 and 5
   Function: A light source is composed of a matrix shaped or stripe-shaped light source and a light directivity separating element.
   Advantage: An illumination with selectable different directivities can be obtained.

32. Corresponding figures: At least FIGS. 3, 4, 5, 6A to 6C, 7, 8, 9A and 9B

Function: A light directivity separating element is composed of a lenticular lens or a lens array, and two or more light emitting regions corresponding to each lens exist.

Advantage: An illumination with two or more selectable, different directivities can be obtained 33. A vehicle-mounted video display apparatus according to constitution 32, wherein the lenticular lens or one lens in the lens array and the two light emitting regions corresponding to the one lens are partitioned via a partition wall from another adjacent one lens and two light emitting regions corresponding to the another lens.

Corresponding figures: At least FIGS. 7 and 8

Function: A lenticular lens or each of lenses in a lens array including a light emitting region is partitioned with a partition wall.

Advantage: A crosstalk can be reduced by reducing stray light.

34. A vehicle-mounted video display apparatus according to constitution 27, wherein the light source includes:
first and second light source groups composed of a plurality of light emitting elements; and
first and second light guide portion groups which separately guide luminous fluxes from the first and second light source groups,
wherein a first emitting portion having emitted therefrom the first luminous flux provided for each first light guide portion in the first light guide portion group and a second emitting portion having emitted therefrom the second luminous flux provided for each second light guide portion in the second light guide portion group are positioned alternately in a direction which is substantially parallel to a line segment connecting the observer at the driver's seat side and the observer at the passenger's seat side, and
the optical element includes a light directivity separating element for providing directivity in two directivities between the observer at the driver's seat side and the observer at the passenger's seat side depending on a position of the light emitting region.
   Corresponding figures: At least FIGS. 19A and 19B
   Effect: A first light source illuminates a first observer via a light directivity separating element by a first light guide portion, and illuminates a second observer via a light directivity separating element by a second light guide portion. In addition, the emission portions of the first light guide portion and second light guide portion are positioned alternately in a horizontal direction.
   Advantage: An illumination having selectable two or more directivities can be achieved at a low cost.

35. A vehicle-mounted video display apparatus according to constitution 24, wherein the illumination unit includes:
a planar light source; and
a liquid crystal cell positioned on the planar light source and partitioned in a matrix shape or stripe shape sandwiched between two polarization plates or polarization separating/reflecting sheets,
wherein a transmission region and a non-transmission region are formed by an ON/OFF operation for each cell of the liquid crystal cells so as to emit the first luminous flux and the second luminous flux in a time divisional manner.
   Corresponding figures: At least FIGS. 16, 17A and 17B
   Function: An illumination is composed of a matrix-shaped or stripe-shaped liquid crystal cell sandwiched between polarization plates or polarization separating/reflecting sheets.
   Advantage: A simple configuration using a conventional planar light source can be provided.

36. A vehicle-mounted video display apparatus according to constitution 32, wherein, when a length from an apex of the transmission-type display element side to an emitting portion of the light element in the lenticular lens or the lens array is “t” and a length of one period in the periodic structure of the lenticular lens or the lens array is P, a relationship 0.56P≦t≦2.3P is obtained.

Corresponding figures: At least FIGS. 23A and 23B

Function: A relationship between a 1-period length P of a lenticular lens or a lens array and a length “t” from a lens apex to a light source is set to be 0.56P≦t≦2.3P.

Advantage: A video can be provided so as to be most visible in location of a driver's seat and a passenger's seat.

37. A vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying a first video whose light source is the first luminous flux emitted from the illumination unit and a second video whose light source is the second luminous flux, respectively, in a time divisional manner by means of raster scanning; and
a display mode switching unit to switch between a multiple video display mode in which the transmission-type display element displays the first video and second video in a time divisional manner and a single video display mode in which the transmission-type display element displays any one of the first video and the second video.
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.
   Corresponding figures: At least FIGS. 21A and 21B
   Function: A display mode switching unit is provided for switching a multiple video display mode and a single video display mode, and further, a video separating angle is set within the range of 25 degrees to 35 degrees with respect to each of the left and right.
   Advantage: A multiple video display mode and a single video display mode can be switched according to a use scene, and a video according to the switched mode can be observed by the observers at the driver's seat and at the passenger's seat, respectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
an illumination switching unit which sequentially switches the two light fluxes emitted from the illumination unit in synchronism with movement of a boundary portion between the first video and the second video in the display screen of the transmission-type display element.

2. A video display apparatus according to claim 1, wherein the illumination unit includes:
a light source capable of selectively emitting light beam in a time divisional manner for each light emitting region divided into a plurality of regions; and
an optical element which emits in at least two different directions the first luminous flux and the second luminous flux selectively emitted as light beams in a time divisional manner from the light source, respectively.

3. A video display apparatus according to claim 1, wherein the illumination switching unit controls the illumination unit so as not to illuminate a region corresponding to the boundary portion.

4. A video display apparatus according to claim 1, wherein the movement direction of the boundary portion between the first video and the second video, in the transmission-type display element, is substantially parallel to a line segment connecting an observing position of the first video and an observing position of the second video.

5. A video display apparatus according to claim 1, wherein the first video and the second video are identical to each other.

6. A video display apparatus according to claim 1, wherein the first video and the second video are different from each other.

7. A video display apparatus according to claim 1, wherein a light scattering element is positioned between the illumination unit and the transmission-type display element, and a scattering property of the light scattering element in a direction substantially parallel to a line segment connecting a first observer who observes the first video and a second observer who observes the second video is small as compared with a scattering property of the light scattering element in a direction substantially vertical to the line segment.

8. A video display apparatus according to claim 2, wherein the light source include a light source having a plurality of light emitting regions composed of a plurality of light emitting elements arranged in a matrix shape or strip shape, and
the optical element includes a light directivity separating element for providing directivity in a direction different depending on a position of the light emitting region.

9. A video display apparatus according to claim 8, wherein the optical directivity separating element is composed of a lenticular lens or a lens array having a periodic structure, and
there exist the at least two or more light emitting regions corresponding to a lens for each period.

10. A video display apparatus according to claim 9, wherein the lenticular lens or one lens in the lens array and the two light emitting regions corresponding to the one lens are partitioned from another adjacent one lens and the two light emitting regions corresponding to the another lens via a partition wall.

11. A video display apparatus according to claim 2, wherein the light source includes:
first and second light source groups composed of a plurality of light emitting elements; and
first and second light guide portion groups which separately guide luminous fluxes from the first and second light source groups,
a first emitting portion having emitted therefrom the first luminous flux provided for each first light guide portion in the first light guide portion group and a second emitting portion having emitted therefrom the second luminous flux provided for each second light guide portion in the second light guide portion group are positioned alternately in a direction which is substantially parallel to a line segment connecting a first observer who observes the first video and a second observer who observes the second video, and
the optical element includes a light directivity separating element for providing directivity of a direction which is different depending on a position between the first emitting portion and the second emitting portion.

12. A video display apparatus according to claim 1, wherein the illumination unit includes:
a planar light source; and
a liquid crystal cell positioned on the planar light source and partitioned in a matrix shape or stripe shape sandwiched between two polarization plates or polarization separating/reflecting sheets, and
a transmission region and anon-transmission region are formed by an ON/OFF operation for each cell of the liquid crystal cells so as to emit the first luminous flux and the second luminous flux in a time divisional manner.

13. A video display apparatus having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner by means of raster scanning a first video whose light source is the first luminous flux and a second video whose light source is the second luminous flux, emitted from the illumination unit; and
a display mode switching unit to switch between a multiple video display mode in which the transmission-type display element displays the first video and second video in a time divisional manner and a single video display mode in which the transmission-type display element displays any one of the first video and the second video.

14. A three-dimensional video display apparatus for inputting a corresponding parallax video into each of left and right eyes in one observer to display a three-dimensional video, the apparatus comprising:
an illumination unit which emits a first luminous flux and a second luminous flux in two directions which correspond to the left and right eyes in a time divisional manner;
a transmission-type display element capable of displaying respectively in a time divisional manner by means of raster scanning a first video whose light source is the first luminous flux and a second video whose light source is the second luminous flux, emitted from the illumination unit, the first video being input into the left eye and the second video being input into the right eye; and
an illumination switching unit which sequentially switches the two luminous fluxes emitted from the illumination unit in synchronism with movement of a boundary portion between the first video and the second video in a display screen of the transmission-type display element.

15. A three-dimensional video display apparatus according to claim 14, wherein the illumination unit includes:
a light source capable of selectively emitting light beams in a time divisional manner for each light emitting region divided in a plurality of regions; and
an optical element which emits the first luminous flux and the second luminous flux selectively emitted in a time divisional manner from the light source in two directions which correspond to the left and right eyes, respectively.

16. A three-dimensional video display apparatus according to claim 14, wherein the illumination switching unit controls the illumination unit so as not to illuminate a region corresponding to the boundary portion.

17. A three-dimensional video display apparatus according to claim 14, wherein the movement direction of the boundary portion between the first video and the second video, in the transmission-type display element, is substantially parallel to a line segment connecting the left and right eyes.

18. A three-dimensional video display apparatus according to claim 14, wherein a light scattering element is positioned between the illumination unit and the transmission-type display element, and a scattering property of the light scattering element in a direction which is substantially parallel to the line segment connecting the left and right eye is small as compared with a scattering property of the light scattering element in a direction which is substantially vertical to the line segment.

19. A three-dimensional video display apparatus according to claim 15, wherein the light source includes a light source having a plurality of light emitting regions composed of a plurality of light emitting elements arranged in a matrix shape or a stripe shape, and
the optimal element includes a light directory separating element for providing directivity in a direction which corresponds to the left and right eyes depending on a position of the light emitting region.

20. A three-dimensional video display apparatus according to claim 19, wherein the light directivity separating element is composed of a lenticular lens or a lens array having a periodic structure, and
there exist the at least two light emitting regions corresponding to a lens for each period.

21. A three-dimensional video display apparatus according to claim 20, wherein the lenticular lens or one lens in the lens array and the two light emitting regions corresponding to the one lens are partitioned via a partition wall from another adjacent one lens and two light emitting regions corresponding to the another lens.

22. A three-dimensional video display apparatus according to claim 14, wherein the light source includes:
first and second light source groups composed of a plurality of light emitting elements; and
first and second light guide portion groups which separately guide luminous fluxes from the first and second light source groups,
wherein a first emitting portion having emitted therefrom the first luminous flux provided for each first light guide portion in the first light guide portion group and a second emitting portion having emitted therefrom the second luminous flux provided for each second light guiding portion in the second light guiding portion group are positioned alternately in a direction which is substantially parallel to a line segment connecting the left and right eyes, and
the optical element includes a light directory separating element for providing directivity in a direction which corresponds to the left and right eyes depending on a position between the first emitting portion and the second emitting portion.

23. A three-dimensional video display apparatus according to claim 14, wherein the illumination unit includes:
a planar light source; and
a liquid crystal cell positioned on the planar light source and partitioned in a matrix shape or stripe shape sandwiched between two polarization plates or polarization separating/reflecting sheets,
wherein a transmission region and a non-transmission region are formed by an ON/OFF operation with respect to each cell of the liquid crystal cells so as to emit the first luminous flux and the second luminous flux in a time divisional manner.

24. A vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner; and
a transmission-type display element capable of displaying respectively in a time divisional manner a first video whose light source is the first luminous flux and a second video whose light source is the second luminous flux, emitted from the illumination unit;
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.

25. A vehicle-mounted video display apparatus according to claim 24, further comprising:
an illumination switching unit which, when the transmission-type display element is a display element capable of displaying the first video and the second video in a time divisional manner by means of raster scanning, respectively, sequentially switches the two luminous fluxes emitted from the illumination unit in synchronism with movement of a boundary portion between the first video and the second video in a display screen of the transmission-type display element.

26. A three-dimensional video display apparatus according to claim 25, wherein the illumination switching unit controls the illumination unit so as not to illuminate a region corresponding to the boundary portion.

27. A vehicle-mounted video display apparatus according to claim 24, wherein the illumination unit includes:
a light source capable of selectively emitting light beams in a time divisional manner for each light emitting region divided into a plurality of regions; and
an optical element which emits the first luminous flux and the second luminous flux selectively emitted as light beams in a time divisional manner from the light source toward the observer at the driver's seat side and the observer at the passenger's seat side, respectively.

28. A vehicle-mounted video display apparatus according to claim 24, wherein the first video and the second video are identical to each other.

29. A vehicle-mounted video display apparatus according to claim 24, wherein the first video and the second video are different from each other.

30. A three-dimensional video display apparatus according to claim 24, wherein a light scattering element is positioned between the illumination unit and the transmission-type display element, and a scattering property of the light scattering element in a direction substantially parallel to a line segment connecting the observer at the driver's seat side and the observer at the passenger's seat side is small as compared with a scattering property of the light scattering element in a direction substantially vertical to the line segment.

31. A vehicle-mounted video display apparatus according to claim 27, wherein the light source includes a light source having a plurality light emitting regions composed of a plurality of light emitting elements arranged in a matrix shape or in a stripe shape, and
the optical element includes a light directivity separating element for providing directivity in two directions between the observer at the driver's seat side and the observer at the passenger's seat side depending on a position of the light emitting region.

32. A vehicle-mounted video display apparatus according to claim 31, wherein the light directivity dividing element is composed of a lenticular lens or a lens array having a periodic structure, and
there exist the at least two or more light emitting region corresponding to a lens for each period.

33. A vehicle-mounted video display apparatus according to claim 32, wherein the lenticular lens or one lens in the lens array and the two light emitting regions corresponding to the one lens are partitioned via a partition wall from another adjacent one lens and two light emitting regions corresponding to the another lens.

34. A vehicle-mounted video display apparatus according to claim 27, wherein the light source includes:
first and second light source groups composed of a plurality of light emitting elements; and
first and second light guide portion groups which separately guide luminous fluxes from the first and second light source groups,
wherein a first emitting portion having emitted therefrom the first luminous flux provided for each first light guide portion in the first light guide portion group and a second emitting portion having emitted therefrom the second luminous flux provided for each second light guide portion in the second light guide portion group are positioned alternately in a direction which is substantially parallel to a line segment connecting the observer at the driver's seat side and the observer at the passenger's seat side, and
the optical element includes a light directivity separating element for providing directivity in two directivities between the observer at the driver's seat side and the observer at the passenger's seat side depending on a position of the light emitting region.

35. A vehicle-mounted video display apparatus according to claim 24, wherein the illumination unit includes:
a planar light source; and
a liquid crystal cell positioned on the planar light source and partitioned in a matrix shape or stripe shape sandwiched between two polarization plates or polarization separating/reflecting sheets,
wherein a transmission region and a non-transmission region are formed by an ON/OFF operation for each cell of the liquid crystal cells so as to emit the first luminous flux and the second luminous flux in a time divisional manner.

36. A vehicle-mounted video display apparatus according to claim 32, wherein, when a length from an apex of the transmission-type display element side to an emitting portion of the light element in the lenticular lens or the lens array is “t” and a length of one period in the periodic structure of the lenticular lens or the lens array is P, a relationship 0.56P≦t≦2.3P is obtained.

37. A vehicle-mounted video display apparatus to be installed in a vehicle, having one display screen capable of displaying a video corresponding to each of a plurality of observers, the apparatus comprising:
an illumination unit which emits a first luminous flux and a second luminous flux in at least two different directions in a time divisional manner;
a transmission-type display element capable of displaying respectively in a time divisional manner a first video whose light source is the first luminous flux and a second video whose light source is the second luminous flux, emitted from the illumination unit; and
a display mode switching unit to switch between a multiple video display mode in which the transmission-type display element displays the first video and second video in a time divisional manner and a single video display mode in which the transmission-type display element displays any one of the first video and the second video.
wherein a separation angle between an optical axis of the first luminous flux and an optical axis of the second luminous flux is set in the range of about 25 degrees to about 35 degrees at the left and right in a substantially horizontal direction around a normal of the display screen so that an observer at the driver's seat side can observe the first video and an observer at the passenger's seat side can observe the second video, respectively.
